(19) United States
(12) Patent Application Publication
(10) Pub. No.: US 2004/0054809 A1
(43) Pub. Date: Mar. 18, 2004

(54) Synchronous object unification protocol

(76) Inventor: Max K. Goff, Reno, NV (US)

Correspondence Address: PARK, VAUGHAN & FLEMING LLP, 508 SECOND STREET, SUITE 201, DAVIS, CA, 95616, US

(21) Appl. No.: 10/189,053

(22) Filed: Aug. 26, 2002

(51) Int. Cl. G06F 15/16

(52) U.S. Cl. 709/248

(57) ABSTRACT

One embodiment of the present invention provides a system that coordinates timing of events related to objects within a distributed computing system. During operation, the system receives a request to set a time base associated with an object to a current time value. This request is received through a protocol associated with the object. In response to the request, the system sets the time base associated with the object to the current time value, so that subsequent operations involving the object can be synchronized. In a variation on this embodiment, the object is defined within an object-oriented programming system, and the object is defined to include the time base.

### BACKGROUND

1. Field of the Invention

The present invention relates to distributed computing systems. More specifically, the present invention relates to a method and an apparatus for precisely coordinating events within a distributed computing system relative to a time base.

2. Related Art

As computer networks continue to proliferate, it is becoming progressively easier for geographically distributed computer systems to work together in performing computational tasks. Historically, such cooperation has been restricted by significant delays and bandwidth limitations involved in communicating between geographically distributed computer systems—which may possibly be separated by thousands of miles.

However, as the networking infrastructure continues to improve, these delays and bandwidth limitations have been dramatically reduced. This makes it possible for a distributed application to effectively operate on a set of geographically distributed computing nodes in the same way as a distributed application operates on a set of local computing nodes in a local cluster.

However, synchronizing activities between geographically distributed computing nodes can be very challenging. Unlike computing nodes in a tightly coupled parallel processing system, geographically distributed computing nodes do not share a centralized clock signal that can be used to synchronize the computing nodes. Furthermore, unlike nodes in a local cluster, geographically distributed computing nodes do not share a local network through which synchronization commands can be sent to synchronize the computing nodes.

What is needed is a method and an apparatus that facilitates synchronizing actions of a set of geographically distributed computing nodes.

More specifically, what is needed is a method and an apparatus that facilitates composability of network components. Composability allows a component to be developed independently and then subsequently integrated into an ensemble of components without disturbing the ensemble or refuting prior service guarantees. Akin to an orchestra playing together, each additional instrument added to the mix must be aware of the context in which other instruments are playing, as well as the time synchronization necessary to ensure that each part being played is within reasonable temporal precision viz, the other parts.

### SUMMARY

One embodiment of the present invention provides a system that coordinates timing of events related to objects within a distributed computing system. During operation, the system receives a request to set a time base associated with an object to a current time value. This request is received through a protocol associated with the object. In response to the request, the system sets the time base associated with the object to the current time value, so that subsequent operations involving the object can be synchronized.

In a variation on this embodiment, the object is defined within an object-oriented programming system, and the object is defined to include the time base.

In a variation on this embodiment, the system additionally receives a request to get time the current time value. In response to this request, the system extracts the current time value from a global time base, and returns the current time value.

In a variation on this embodiment, extracting the current time value from the global time base involves extracting the current time value from a Global Positioning System (GPS) signal.

In a variation on this embodiment, extracting the current time value from the global time base involves extracting the current time value from a local timer that has been recently updated with reference to a Global Positioning System (GPS) signal.

In a variation on this embodiment, the time base associated with the object contains an advancing time value that keeps track of time relative to a local time base.

In a variation on this embodiment, the time base associated with the object contains a fixed time value.

In a variation on this embodiment, the system uses the time base associated with the object to coordinate events with other entities in the distributed computing system. These other entities can include other objects with associated time bases, and may be located on other nodes in the distributed computing system.

In a variation on this embodiment, the distributed computing system includes geographically distributed nodes.

### BRIEF DESCRIPTION OF THE FIGURES

FIG. 1 illustrates a distributed computing system in accordance with an embodiment of the present invention.

FIG. 2 is a flow chart illustrating the process of using GPS signals to synchronize multiple computer systems on a stationary network in accordance with an embodiment of the present invention.

FIG. 3 is a flow chart illustrating the process of servicing a request for a current time value in accordance with an embodiment of the present invention.

FIG. 4 is a flow chart illustrating the process of servicing a request to set a time base associated with an object in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Distributed Computing System

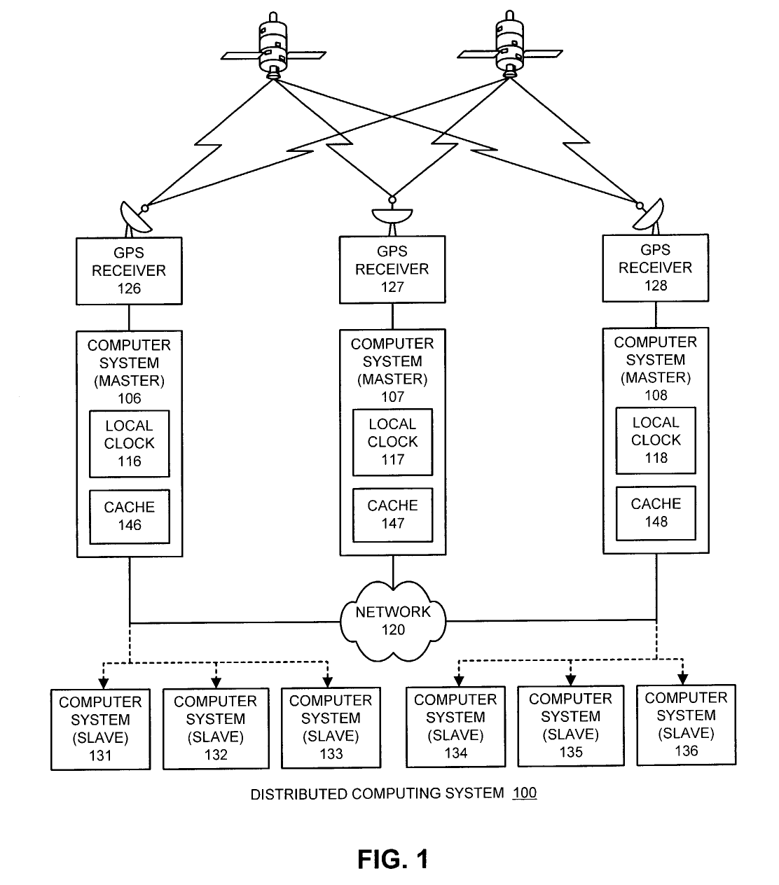

FIG. 1 illustrates a distributed computing system 100 in accordance with an embodiment of the present invention. Distributed computing system 100 includes a number of master computer systems 106-108, which are coupled to network 120. Master computer systems 106-108 can include geographically distributed computing nodes, or alternatively, can include nodes that are part of the same local network or cluster. Network 120 can generally include any type of wire or wireless communication channel capable of coupling together computer systems. This includes, but is not limited to, a local area network, a wide area network, or a combination of networks. In one embodiment of the present invention, network 120 includes the Internet.

Note that master computer system 106 communicates with slave computer systems 131-133, and master computer system 108 communicates with slave computer systems 134-136. This communication can take place through separate local area networks, or alternatively, through network 120.

Master computer systems 104-106 and slave computer systems 131-136 can generally include any type of computer system, including, but not limited to, a computer system based on a microprocessor, a mainframe computer, a digital signal processor, a device controller, and a computational engine within an appliance.

Master computer systems 106-108 are coupled to Global Positioning System (GPS) receivers 126-128, respectively. GPS receivers 126-128 communicate with one or more GPS satellites 101-102 to obtain time base information. Note that signals from two different GPS satellites are required to determine a geographical location. However, once a geographical location of a receiver is known, only signals from one GPS satellite are needed to determine time base information.

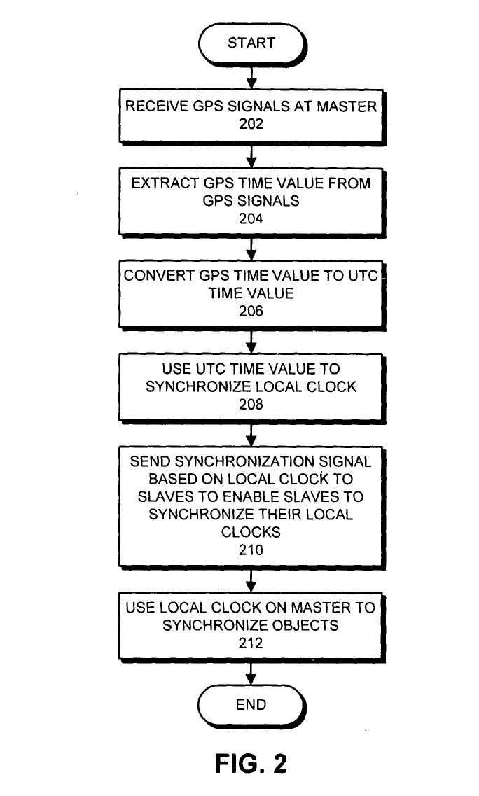

Master computer systems 104-106 use time base information obtained through GPS receivers 126-128 to periodically synchronize local clocks 116-118 within master computer systems 106-108, respectively. Master computer system 106 can then communicate with slave computer systems 131-133 to synchronize local clocks on slave computer systems 131-133 (not shown). Master computer system 108 can similarly communicate with slave computer systems 134-136 to synchronize local clocks on slave computer systems 134-136 (not shown). This synchronization process is described in more detail below with reference to FIG. 2.

Process of Synchronizing Local Clock Signals

FIG. 2 is a flow chart illustrating the process of using GPS signals to synchronize multiple computing systems on a stationary network in accordance with an embodiment of the present invention.

The system starts by receiving GPS signals at master computer systems 104-106 (step 202). In order to obtain more accuracy, this may involve additionally receiving differential GPS (DGPS) signals, Wide Area Augmentation System (WAAS) signals, or Local Area Augmentation System (LAAS) signals. DGPS signals and LAAS signals are additional signals that are received from a ground station to provide additional accuracy, while the WAAS signals are additional signals that are received from geosynchronous satellites to provide additional accuracy.

Next, the system extracts a GPS time value from the GPS signals at master computer systems 104-106 (step 204). Note that extracting the time value from the GPS signals can involve using Precise Positioning Service (PPS) signals within the GPS signals to obtain a time value that is accurate to within 200 nanoseconds. Alternatively, it can involve using Standard Positioning Service (SPS) signals within the GPS signals to obtain a time value that is accurate to within 340 nanoseconds.

Note that PPS signals have historically only been available to authorized users with cryptographic equipment and keys and specially equipped receivers, such as U.S. and Allied military, certain U.S. Government agencies, and selected civil users specifically approved by the U.S. Government. Other users had to use the Standard Positioning Service, which is somewhat less accurate in specifying geographical locations and times.

Next, the system optionally converts the GPS time values into corresponding Universal Coordinated Time (UTC) time values by using UTC correction parameters contained in the GPS signals (step 206). Note that GPS time does not take into account leap seconds and is consequently drifting ahead of UTC time.

The system then uses the UTC time values to synchronize (reset) the local clocks 116-118 at master computer systems 106-108 (step 208).

Master computer systems 106-108 can then send synchronization signals to slave computer systems (step 210). In particular, master computer system 106 can send synchronization signals to slave computer systems 131-133. These synchronization signals enable slave computer systems 131-133 to synchronize their local clocks with local clock 116 in master computer system 106.

Similarly, master computer system 108 can send synchronization signals to slave computer systems 134-136. These synchronization signals enable slave computer systems 134-136 to synchronize their local clocks with local clock 118 in master computer system 108.

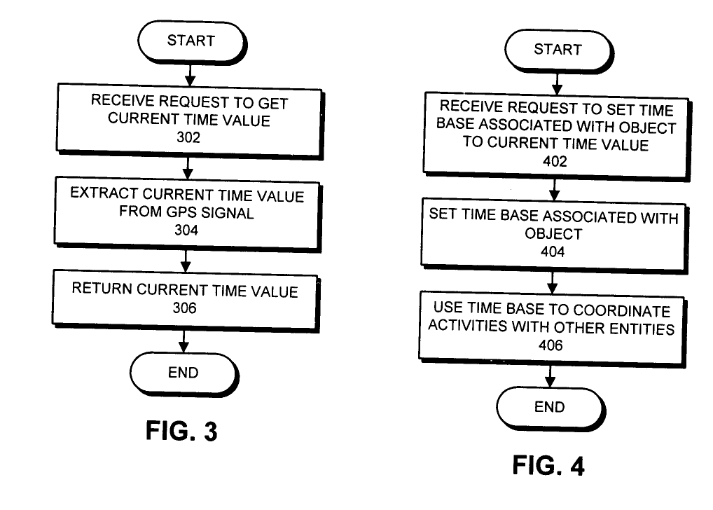

Next, the system uses local clocks 116-118 within master computer systems 106-108, respectively, to synchronize objects within master computer systems 106-108 as is described below with reference to FIGS. 3 and 4 (step 212).

Request for a Current Time Value

FIG. 3 is a flow chart illustrating the process of servicing a request for a current time value in accordance with an embodiment of the present invention. During operation, the system receives a request to get a current time value (step 302). Note that this request can be received in a format that adheres to a specific protocol. In response to this request, the system extracts the current time value from GPS signals as is described above with reference to FIG. 2 (step 304). Alternatively, the system can extract the current time value from a local timer that has been recently updated with reference to a Global Positioning System (GPS) signal. Next, the system returns the extracted time value (step 306).

Request to Set a Time Base Associated with and Object

FIG. 4 is a flow chart illustrating the process of servicing a request to set a time base associated with an object in accordance with an embodiment of the present invention. During operation, the system receives a request to set a time base associated with the object to the current time value (step 402). Note that the object can include a “time base field” which contains an advancing time value. This time base field can keep track of time relative to a local time base, for example, by specifying an offset relative to the local time base. Alternatively, the time base within the object can contain a fixed time value, in which case the time base is a “time stamp.”

In response to the request, the system sets the time base associated with the object to the current time value (step 404). The system subsequently uses the time base to coordinate activities with other entities in the distributed computing system (step 406). For example, the system can coordinate actions of geographically distributed components that form the backbone of a communication system to dynamically route data across a communication network.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for coordinating timing of events related to objects within a distributed computing system, comprising:
receiving a request to set a time base associated with an object to a current time value;
wherein the request is received through a protocol associated with the object; and
in response to the request, setting the time base associated with the object to the current time value, so that subsequent operations involving the object can be synchronized.

2. The method of claim 1,
wherein the object is defined within an object-oriented programming system; and
wherein the object is defined to include the time base.

3. The method of claim 1, further comprising:
receiving a request to get time the current time value;
in response to the request,
extracting the current time value from a global time base, and
returning the current time value.

4. The method of claim 3, wherein extracting the current time value from the global time base involves extracting the current time value from a Global Positioning System (GPS) signal.

5. The method of claim 3, wherein extracting the current time value from the global time base involves extracting the current time value from a local timer that has been recently updated with reference to a Global Positioning System (GPS) signal.

6. The method of claim 1, wherein the time base associated with the object contains an advancing time value that keeps track of time relative to a local time base.

7. The method of claim 1, wherein the time base associated with the object contains a fixed time value.

8. The method of claim 1, further comprising using the time base associated with the object to coordinate events with other entities in the distributed computing system.

9. The method of claim 8, wherein the other entities include other objects with associated time bases.

10. The method of claim 8, wherein the other entities are located on other nodes in the distributed computing system.

11. The method of claim 1, wherein the distributed computing system includes geographically distributed nodes.

12. A computer-readable storage medium storing instructions that when executed by a computer cause the computer to perform a method for coordinating timing of events related to objects within a distributed computing system, the method comprising:
receiving a request to set a time base associated with an object to a current time value;
wherein the request is received through a protocol associated with the object; and
in response to the request, setting the time base associated with the object to the current time value, so that subsequent operations involving the object can be synchronized.

13. The computer-readable storage medium of claim 12,
wherein the object is defined within an object-oriented programming system; and
wherein the object is defined to include the time base.

14. The computer-readable storage medium of claim 12, wherein the method further comprises:
receiving a request to get time the current time value;
in response to the request,
extracting the current time value from a global time base, and
returning the current time value.

15. The computer-readable storage medium of claim 14, wherein extracting the current time value from the global time base involves extracting the current time value from a Global Positioning System (GPS) signal.

16. The computer-readable storage medium of claim 14, wherein extracting the current time value from the global time base involves extracting the current time value from a local timer that has been recently updated with reference to a Global Positioning System (GPS) signal.

17. The computer-readable storage medium of claim 12, wherein the time base associated with the object contains an advancing time value that keeps track of time relative to a local time base.

18. The computer-readable storage medium of claim 12, wherein the time base associated with the object contains a fixed time value.

19. The computer-readable storage medium of claim 12, wherein the method further comprises using the time base associated with the object to coordinate events with other entities in the distributed computing system.

20. The computer-readable storage medium of claim 19, wherein the other entities include other objects with associated time bases.

21. The computer-readable storage medium of claim 19, wherein the other entities are located on other nodes in the distributed computing system.

22. The computer-readable storage medium of claim 12, wherein the distributed computing system includes geographically distributed nodes.

23. An apparatus that coordinates timing for events related to objects within a distributed computing system, comprising:
a receiving mechanism that is configured to receive a request to set a time base associated with an object to a current time value;
wherein the receiving mechanism receives the request in a format that adheres to a protocol associated with the object; and
a time base setting mechanism, wherein in response to the request, the time base setting mechanism is configured to set the time base associated with the object to the current time value, so that subsequent operations involving the object can be synchronized.

24. The apparatus of claim 23,
wherein the object is defined within an object-oriented programming system; and
wherein the object is defined to include the time base.

25. The apparatus of claim 23,
wherein the receiving mechanism is further configured to receive a request to get time the current time value; and
wherein the apparatus further comprises a time extraction mechanism, wherein in response to the request, the time extraction mechanism is configured to,
extract the current time value from a global time base, and to
return the current time value.

26. The apparatus of claim 25, wherein the time extraction mechanism is configured to extract the current time value from a Global Positioning System (GPS) signal.

27. The apparatus of claim 25, wherein the time extraction mechanism is configured to extract the current time value from a local timer that has been recently updated with reference to a Global Positioning System (GPS) signal.

28. The apparatus of claim 23, wherein the time base associated with the object contains an advancing time value that keeps track of time relative to a local time base.

29. The apparatus of claim 23, wherein the time base associated with the object contains a fixed time value.

30. The apparatus of claim 23, further comprising an execution mechanism that uses the time base associated with the object to coordinate events with other entities in the distributed computing system.

31. The apparatus of claim 30, wherein the other entities include other objects with associated time bases.

32. The apparatus of claim 30, wherein the other entities are located on other nodes in the distributed computing system.

33. The apparatus of claim 23, wherein the distributed computing system includes geographically distributed nodes.
